(19) United States
(12) Patent Application Publication
(10) Pub. No.: US 2024/0231885 A1
(43) Pub. Date: Jul. 11, 2024

(54) Method and system for optimizing live migration of a virtual machine from a source server to a destination server

(71) Applicants: Zhi WANG, Helsinki (FI); Binbin WU, Shanghai (CN); Guang ZENG, Shanghai (CN)

(72) Inventors: Zhi WANG, Helsinki (FI); Binbin WU, Shanghai (CN); Guang ZENG, Shanghai (CN)

(21) Appl. No.: 18/617,684

(22) Filed: Mar. 27, 2024

(30) Foreign Application Priority Data
Jul. 13, 2023 (WO) PCT/CN2023/107133

(51) Int. Cl. G06F 9/455

(52) U.S. Cl. CPC G06F 9/45558; G06F 2009/4557; G06F 2009/45595

(57) ABSTRACT

A method and system for optimizing live migration of a virtual machine (VM) from a source server to a destination server where hardware accelerator virtualization is used. Hardware accelerator performance data is obtained while executing a workload on a virtual function at the source server. It is determined whether to transfer the workload from the source server to the destination server based on the hardware accelerator performance data. The workload is transferred from the source server to the destination server based on the determination. The hardware accelerator performance data may include an amount of output data the workload generates and an amount of input data to the workload. The hardware accelerator may be a graphics processing unit (GPU), and the workload may be a GPU workload.

### BACKGROUND

Virtual machine (VM) live migration is a technology that provides a running VM with the capability to be moved among different physical machines without disconnecting the client, for example, by migrating the states (e.g., of CPU, memory, storage, etc.) of a VM from one node to another (e.g., from a source server to a destination server).

The process of live migration used in the cloud includes several stages, including pre-copy, stop-and-copy, post-copy, and finish stages. The purpose of the pre-copy stage is to transfer the data and states as much as possible when the source VM is still alive so that there will be less data left to transfer in the next stage when both the source server and destination server are suspended. As the applications in the source VM are still running in this stage, the hypervisor or virtual machine manager (VMM) monitors the changes of the virtual states and keeps transferring them from the source server to the destination server. When the data to be copied lessens over time and appears to be converging, the VMM may transition from the pre-copy stage to the next stage.

In the stop-and-copy stage, user applications will not respond because the source server and the destination server are both suspended. The rest of the virtual states are typically copied from the source to the destination as fast as possible during this stage as the time cost in this stage can heavily affect the service level agreement (SLA).

Some VMMs support post-copy, which means that the destination server will start to run as long as the necessary data is transferred. The rest of the data transfer will continue in the background. If the destination touches memory or states that have not been copied yet, the

VMM will trap this event and copy it first.

In the finish stage, the VM in the destination server is resumed and the VM in the source server is destroyed. At this point, the live migration is done.

### BRIEF DESCRIPTION OF THE FIGURES

Some examples of apparatuses and/or methods will be described in the following by way of example only, and with reference to the accompanying figures, in which

FIG. 1 shows a system including a source server and a destination server and a flow for live migration of a VM from the source server to the destination server in accordance with one example;

FIG. 2 shows an example process of migrating a VM from a source server to a destination server;

FIG. 3 shows an example of graphics processing unit (GPU) performance counters;

FIG. 4 is a flow diagram of an examples process for optimizing live migration of a VM from a source server to a destination server where hardware accelerator virtualization is used;

FIG. 5 is a block diagram of an examples compute system for optimizing live migration of a VM from a source server to a destination server where hardware accelerator virtualization is used;

FIG. 6 is a block diagram of an electronic apparatus incorporating at least one electronic assembly and/or method described herein;

FIG. 7 illustrates a computing device in accordance with one implementation of the invention; and

FIG. 8 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

With the rise of the use of hardware accelerators (e.g., graphics processing units (GPUs), artificial intelligence (AI) accelerators, field-programmable gate arrays (FPGAs), etc.), hardware accelerator virtualization technology is now receiving more attention in the cloud market. Hardware accelerators are purpose-built devices for specific functions or workloads. A virtualization-friendly hardware accelerator is usually presented as a peripheral component interconnect (PCI) device with a number of PCI virtual functions (VFs). Each PCI VF is passed through into a VM for a given tenant that wishes to use the accelerator inside the VM machine.

Hereafter, example schemes are explained for optimizing live migration of a VM from a source server to a destination server where hardware accelerator virtualization is used. It should be noted that the examples will be explained with reference to GPU virtualization as one example and the examples are applicable to any hardware accelerator virtualization.

In hardware GPU virtualization, the GPU will expose several PCI virtual functions, e.g., GPU virtual functions (VFs). Each GPU VF will be passed to the VM for the tenants who bought the GPU acceleration service from the cloud service provider (CSP). The virtual machine monitor (VMM) controls the device states, saves and restores the device states, and tracks the dirty pages generated by the on-flying workload during different stages of live migration, while an IO mediator, which sits between the VMM and GPU VF, controls the actual GPU hardware during the live migration.

Some GPU workloads (e.g., video decoding workloads) modify a lot of pages in the local and system memory. The pages are marked as “dirty pages”. When such a workload is running in a VM during live migration, the cloud service provider (CSP) faces a number of challenges.

Running GPU workload in the VM during the live migration can generate a large number of dirty pages, which can cause poor performance, unacceptable downtime, and extremely long migration time, and the live migration could fail due to the poor usability.

In order to address this problem, hardware vendors may try to throttle the GPU workload submission in different software and firmware layers to promise the success of the live migration. However, this comes with side effects on timing-sensitive workloads. CSPs may try to address the problem by installing a guest agent to control the workload submission from the user stack, throttling the CPU usage to let the live migration coverage, or obtaining more network bandwidth by updating to network infrastructure.

Example schemes are disclosed herein for optimizing dirty page copying in live migration of a VM from a source server to a destination server where hardware GPU virtualization is used. In examples, dirty page copying for a GPU workload (e.g., GPU rendering workload, etc.) is optimized during VM live migration. The optimization for dirty page copying for a GPU workload during VM live migration may be made based on the GPU performance data, for example by dynamically detecting the workload characteristics from the GPU performance data (e.g., GPU pipeline performance data).

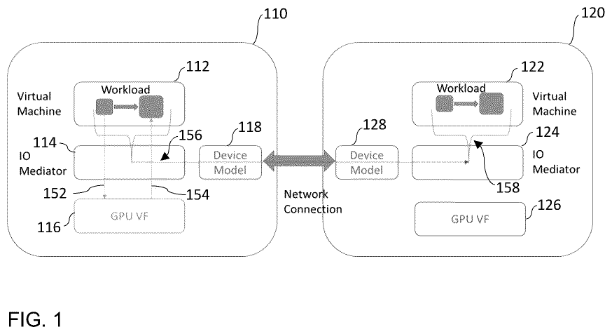

FIG. 1 shows a system including a source server 110 and a destination server 120 and a flow for live migration of a VM from the source server 110 to the destination server 120 in accordance with one example. VMs 112 and 122 are set up in a source server 110 and a destination server 120, respectively. In the source server 110, a GPU workload is submitted from the VM 112 to the GPU VF 116 via the IO mediator 114 (152). The GPU VF then generates output data for the GPU workload (154).

The IO mediator 114 in the source server 110 obtains the GPU performance data while executing the GPU workload on a GPU virtual function 116 at the source server 110. For example, the GPU performance data may be the amount of output data the GPU workload generates and the amount of input data to the GPU workload. For example, the GPU performance data may be obtained by inserting, by the IO mediator 114 in the source server 110, a GPU performance command when submitting the GPU workload to the GPU virtual function 116.

The IO mediator 114 then determines whether to transfer the GPU workload from the source server 110 to the destination server 120 based on the GPU performance data. The IO mediator 114 may determine the characteristics of the GPU workload based on the performance data, (e.g., the ratio between the GPU workload input data from the application and the output data written by the GPU hardware). The IO mediator 114 may determine whether the GPU workload is generating large output data (dirty pages) compared to the amount of input data and determines whether to transfer the GPU workload from the source server 110 to the destination server 120 based on that. The IO mediator 114 may transfer either the output data generated by the GPU workload and marked as dirty page or the GPU workload from the source server 110 to the destination server 120 based on the determination (156). For example, if it is determined that the ratio of the amount of output data the GPU workload generates to the amount of input data to the GPU workload does not exceed a threshold, the output data marked as dirty page is transferred to the destination server. If it is determined that the ratio of the amount of output data the GPU workload generates to the amount of input data to the GPU workload exceeds the threshold, the IO mediator 114 in the source server 110 may transfer the GPU workload to the destination server. The IO mediator 114 in the source server 110 may pack the GPU workload and stream the GPU workload within a live migration bitstream to the destination server.

The IO mediator 124 in the destination server 120 unpacks the GPU workload from the live migration bitstream and executes it in the destination machine (e.g., the GPU VF 126 in the destination server 120) (158).

If it is determined that the transfer of the GPU workload is preferable based on the GPU performance data (e.g., the ratio of the amount of output data the GPU workload generates to the amount of input data to the GPU workload exceeds the threshold), the IO mediator 114, instead of marking all the input and output memory pages as dirty, which results in the problem discussed above, may pack the GPU workload, transfer the GPU workload through the live migration bitstream, and let the IO mediator 124 in the destination server 120 execute it and generate the expected output directly in the destination server 120. With this scheme, a transfer of large portions of dirty pages can be avoided.

In some applications, skipping transfer of the dirty pages generated by GPU media workload may save 9%˜74% of network bandwidth. With the data estimation, the performance metrics of live migration will be significantly improved.

The example schemes for optimizing the dirty page copying in live migration of a VM from a source server to a destination server may be applied to GPU rendering workload. Alternatively, the example schemes may also be applied to other GPU workloads, for example GPU three-dimension (3D) workloads, artificial intelligence (AI) workloads, media workloads, etc.

A typical process of GPU rendering workloads includes several stages including loading the 3D model, transforming the 3D model, rasterization, depth testing, and display. 1) Loading the 3D model: The 3D model is first loaded into the GPU memory from the storage. 2) Transforming the 3D model: The GPU transforms the 3D model into a more efficient format that can be processed faster. This includes operations such as vertex shading, tessellation, and geometry shading. 3) Rasterization: The transformed 3D model is then rasterized, which involves converting the 3D model into 2D triangles that can be displayed on a screen. This step also involves shading the triangles using a lighting model and applying textures to the model. 4) Depth testing: The GPU then performs depth testing, which involves determining which triangles are in front of or behind other triangles. This is important for correctly rendering the 3D model in the correct order. 5) Display: The final step is to display the rendered 3D model on the screen. This involves transferring the image data from the GPU memory to the display driver, which then sends the image data to the display device.

Analysis of the input and output data of GPU rendering workload.

### 3D Modeling (Stages 1 and 2)

For 3D modeling, the size of vertices in a 3D scene is typically measured in terms of the number of bits used to store each coordinate. In most cases, vertices are represented using floating point values, which are stored using a fixed number of bits (e.g., 32 bits for a single-precision floating point value). The typical sizes of vertices that are commonly used in 3D scenes are 1) low-resolution models: single-precision (32-bit) floating point values for each coordinate, 2) medium-resolution models: single-precision (32-bit) floating point values for each coordinate, and 3) high-resolution models: double-precision (64-bit) floating point values for each coordinate.

The number of coordinates used in a typical 3D scene can vary widely depending on the specific needs of the project and the level of detail required for the models and environments. In general, more complex and detailed models and environments will require more coordinates to represent them accurately, while simpler models and environments will require fewer coordinates. The specific number of coordinates that are commonly used in 3D scenes are 1) low-resolution models: fewer than 10,000 coordinates, 2) medium resolution models: 10,000-100,000 coordinates, and 3) high-resolution models: 100,000-1,000,000 coordinates or more. With the data above, vertices in a 3D scene can range from 100 KB to 7 MB.

Rasterization (Stage 3)

The data can be much more significant for the 3D texture used in rasterization than in the modeling stage. According to the documentation of the UNITY 3D engine manual, which is well-respect and widely used in the industry, the size of a 3D texture in memory and on disk increases quickly as its resolution increases. An RGBA32 3D texture with no mipmaps and a resolution of 16×16×16 has a size of 128 KB, but with a resolution of 256×256×256, it has a size of 512 MB.

Choosing the resolution of the textures is decided by the requirements, for example, 1) low resolution (for distant objects or low detail areas): 256×256 pixels or smaller, 2) medium resolution (for mid-range objects or medium detail areas): 512×512 pixels or larger, and 3) high resolution (for close-up objects or high-detail areas): 1024×1024 pixels or larger.

With the data above, the size of one texture can be from 512 MB to 8 GB. Many GPU HW implements texture compression to reduce the storage cost, like DXT from Microsoft, PVRTC from PowerVR, and ETC from Ericsson, which promises about a 50%-60% compression ratio in general. So, the size of one texture uploaded into the GPU can be from 256 MB to 4 GB. The user can also choose different mipmaps levels to reduce the texture size, resulting in poor texture details.

Furthermore, it is common to use many 3D textures in the 3D game, as each object may have its texture(s). For example, a game with a relatively simple environment (e.g., a single room) might use dozens or hundreds of 3D textures, while a more complex game with a larger, more detailed environment might use thousands of 3D textures. In a 3D modeling or rendering application, the number of 3D textures used in a scene may be more variable, as it will depend on the specific objects and materials being modeled. A simple scene might use just a few 3D textures, while a more complex scene with many different materials and objects might use hundreds or thousands of 3D textures.

### Writing the Render Target and Displaying the Frame (Stages 4 and 5)

The output of the rasterization and depth test is a render target that can be shown by the display engine. The resolution chosen by the application decides the output data size. For example, the 4K render target size with RGBA8888 format is 3840×2160×4/1024/1024=31 MB, and the 2K render target size with RGBA8888 format is 2048×1080×4/1024/1024=8 MB.

The constant changes in the characteristics of GPU rendering workloads can create significant gaps in optimization (dispatching the copy of GPU workload to the destination machine, executing the copy of workload in the remote machine, and skipping the dirty page transfer in the source machine) and lead to poor service level agreements (SLAs). Unlike optimizing the media workload (video encoding and decoding), the characteristics of GPU rendering workload keep changing.

For example, in the cloud gaming scenario, on the input side, a massive amount of texture is loaded in the game loading stage, while on the output side, the render target is primarily a still image. Under this situation, simply transferring the GPU workload based on the type of GPU workload will not help the live migration convergence but will waste the network bandwidth. While in the game-playing stage, on the input side, the model and texture uploading were done in the previous stage, but the render target will be frequently updated. Under this situation, the 2K render target will be updated at 60 fps by the GPU pipeline, and the output side will generate about 8 MB×60 FPS=480 MB dirty page/s. For the 4K render target, the output side will generate about 31 MB×60 FPS=1.9 GB dirty page/s dirty page.

Suppose the downtime of live migration is committed as 16 ms and the network bandwidth is 10 GbE (1.25 GB/s), CSP's most common network infrastructure nowadays. In the pre-copy stage, the network bandwidth of 1.25 GB/s can only support up to 2 tenants with a 2K render target to do live migration simultaneously (1.25 GB/s≥2×480 MB/s). While for tenants with a 4K render target, the network bandwidth is not enough. If the game is in the playing stage, the pre-copy stage might fail due to the sudden large output (1.25 GB/s<1.9 GB/s). Although the render target might be compressed by H.264 or High Efficiency Video Coding (HEVC) and transferred later to the client application, the dirty pages have already been generated.

In the stop-and-copy stage, the worst case is 480 MB (2K render targets) or 1.9 GB (4K render targets) dirty pages must be transferred to the destination server in 16 ms. Optimistically, without any other traffic on the network, transferring 480 MB dirty pages in 10 GbE costs about 384 ms, and 1.9 GB dirty pages costs about 1.5 s. It is impossible to achieve the SLA of downtime.

The success rate (one of essential performance metrics) will be heavily affected in this case, and the network bandwidth occupied by live migration is wasted. It might be even worse if the administer keeps re-trying the live migration but fails repeatedly.

The GPU rendering workload significantly challenges GPU live migration under different usage cases. The characteristics of the GPU rendering workload are changing all the time due to different applications (e.g., 3D game, or 3D modeling) and different stages (e.g., loading the game, game playing, etc.), which brings significant gaps in optimizing the dirty pages copying in the GPU live migration to achieve the SLA.

If an SLA is not met, the customer and the CSP will face significant consequences. For customers, specific workloads that rely on timeliness, such as cloud gaming, virtual reality (VR), and live video broadcasts, may be adversely affected if a virtual machine does not resume on the destination server on time, resulting in lag or screen tearing. For the CSP, failing to meet SLAs for critical customers can damage the company's reputation and market share in the competitive world of cloud computing.

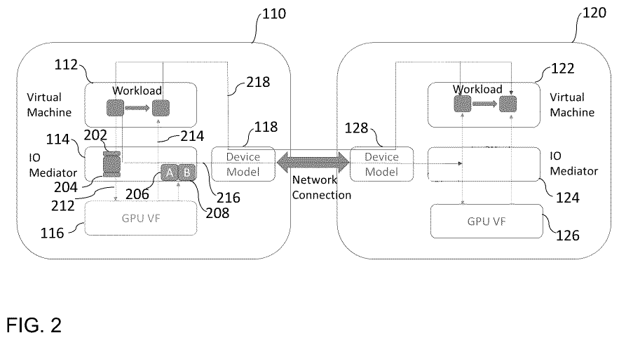

FIG. 2 shows an example process of migrating a VM from a source server 110 to a destination server 120. The GPU workload is submitted from the virtual machine 112 to the GPU VF 116 via the IO mediator 114 (212). The IO mediator 114 in the source server 110 traps the GPU workload submission during the live migration. With the trap of the workload submission, the IO mediator 114 in the source server 110 can peek at the GPU workload submission and analyze the GPU workload before it goes to the GPU VF 116.

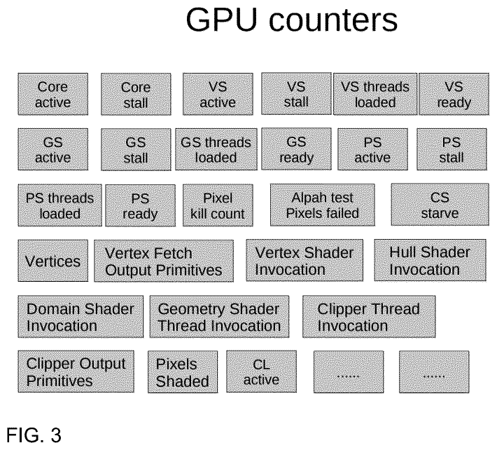

When the virtual machine 112 submits a GPU workload (e.g., a GPU rendering workload), the IO mediator 114 in the source server 110 injects a GPU performance command in the shadow workload ring buffer and submits the workload to the hardware. As shown in FIG. 2, the IO mediator 114 may insert the GPU performance commands 202, 204 in the beginning and end of the shadow ring buffer. The GPU performance command causes the GPU hardware to write a snapshot of GPU performance counters to the address specified in the command. FIG. 3 shows an example of GPU performance counters. In examples, the GPU performance counters are configured to capture the GPU performance data, e.g., the amount of input data to the GPU workload and the amount of output data that the GPU workload generates.

When the GPU workload is finished, the GPU will write the output of the GPU workload and the performance counters snapshot 206, 208 into the graphics memory (214). The IO mediator 114 analyzes the GPU performance data (e.g., the GPU rendering pipeline performance data) to determine the characteristics of the GPU workload. For example, the IO mediator 114 may determine if the GPU workload generates much more output data (dirty pages) than the input data based on the GPU performance counters snapshots.

If the IO mediator 114 determines that the GPU workload does not generate much more output data (dirty pages) than the input data (e.g., in the cloud game loading stage), all the dirty pages will be transferred to the destination server 220 accordingly (218). If the IO mediator determines that the GPU workload generates much more output data (dirty pages) than the input data (e.g., in the cloud game-playing stage), the IO mediator 114 in the source server 110 may transfer the GPU workload to the destination server 120 besides executing the workload to the GPU VF 116 in the source server 110 instead of executing the GPU workload in the source server 110 and having a lot of dirty pages to transfer to the destination server 120.

If the GPU workload is transferred, the IO mediator 124 in the destination server 120 notices the GPU workload in the migration bitstream and executes it on the GPU VF 126 in the destination server 120. Thus, the VM 122 in the destination server 120 will have the same output as the source server's GPU workload. Thus, the IO mediator 114 in the source server 110 can bypass the transfer of the dirty pages which contains the output of the GPU workload.

In examples, by leveraging the GPU performance data, the IO mediator 114 can understand the characteristics of the GPU workload (e.g., if the GPU workload generates many dirty pages compared to the amount of input data) and optimize dirty page copying of the GPU workload (e.g., GPU rendering workload) in live migration with hardware GPU virtualization. The IO mediator 114 in the source server 110 can decide if the GPU workload should be executed both in the source server 110 and the destination server 120 (i.e., if the GPU workload should be transferred to the destination server 120) to avoid copying the large output buffer.

According to the example above, for the 2K render target, 480 MB/s bandwidth per tenant can be saved. For the 4K render target, 1.9 GB/s bandwidth per tenant can be saved. In a 10 GbE network infrastructure, 40% bandwidth per tenant can be saved during the live migration and migrating 4K render target turns possible when a GPU workload is running in a VM.

There are several benefits to significantly decreasing the number of dirty pages that need to be copied during the live migration of a GPU workload. These benefits include reduced downtime, a higher success rate, and a shorter total migration time. This approach is particularly effective in improving performance metrics for GPU rendering workloads.

The example scheme of GPU live migration optimization disclosed herein may be applied to numerous types of GPU workloads, such as media workloads, 3D workloads, AI workloads, rendering workloads, etc.

The GPU hardware virtualization technology in accordance with the example schemes disclosed herein offers a number of advantages. It provides excellent performance metrics for live migration, a high level of service without slowing down tenant GPU workloads or putting additional strain on the network infrastructure. This makes it an attractive option for cloud service providers and their customers, as it allows them to reuse their existing network infrastructure, reducing costs and deployment and maintenance efforts. Additionally, the example schemes disclosed herein enable CSPs to offer a highly competitive solution to tenants with a better service level agreement for live migration.

Before GPU VF and other virtualization-friendly accelerators were introduced to the virtualization world, all virtual devices were emulated by Quick Emulator (QEMU), the device model 118 and 128 in FIGS. 1 and 2. During a live migration, QEMU only needed to manage virtual states, such as guest system memory and virtual device states like the virtual keyboard, mouse, and screen. The QEMU on the source server would pack these virtual states into a bitstream and send them over the network to the QEMU on the destination server, which would then unpack the bitstream and continuously update the virtual states until the live migration process was completed. However, with the introduction of the GPU VF, which is not a virtual device that can be emulated by QEMU, a new layer called the virtual function IO (VFIO) was introduced. The VFIO is a framework in the Linux kernel that allows QEMU to use generic application programming interfaces (APIs) to control and save/load the device states of the GPU VF. The vendor must provide a vendor-specific plugin called the IO mediator, which has in-depth knowledge of the GPU VF device and supports the generic VFIO APIs.

The IO mediator supports device profile selection, enumeration, and several VFIO regions that are used for communication with QEMU. These regions include the PCI configuration, PCI base address register (BAR), and device state management regions. The IO mediator can implement different policies for each region and change these policies at runtime. One possible policy is “passthrough,” in which all access to the region goes directly to the hardware (the GPU VF). The GPU VF PCI MMIO registers BAR always uses passthrough. Another possible policy is “trap,” in which all access to the region is intercepted by the VMM and the IO mediator can then decide how to handle the trap. The PCI configuration region and device state management region always use the “trap” policy.

During a live migration, QEMU saves and restores data belonging to the IO mediator from the bitstream that is transferred over the network. The IO mediator on the source server can pack the data to be transferred into the device state management region, and QEMU will then pack the data from this region into the bitstream for the live migration and send it to the destination server. The QEMU on the destination server will unpack the data and write it to the device state management region of the IO mediator on the destination server, allowing the data to be transferred between the IO mediators on the source and destination servers.

The VMM also provides services to the IO mediator, such as the ability to request that the VMM mark a guest memory page as write-protected and handle a trap if the guest attempts to modify the page. This allows the IO mediator to track a guest memory page.

The process of submitting GPU workloads for a GPU VF has been significantly simplified compared to the process in a native environment. For instance, during the initialization of a GPU VF, the VF kernel-mode driver (KMD) will obtain the resources that have been allocated for this VF, such as the GGTT size and offset and the LMEM size and offset, set up the command communication channel between the VF KMD and the firmware microcontroller (a graphics microcontroller (GuC)), and allocate a pool of GuC contexts.

To submit a GPU workload, the VF KMD will obtain a GuC context from the pool, wrap the workload in the GPU command ring buffer associated with an execlist LRCA context, and send a GuC action through the command communication channel to schedule the GPU workload to run.

To intercept the submission of GPU workloads during a live migration, the IO mediator monitors the command communication channel. In order to do this, the IO mediator needs to determine the structure of the command communication channel so that it can later intercept GPU workload submissions during the live migration. The memory-based command communication channel is established through the GuC memory-mapped input/output (MMIO) communication channel, which is implemented as MMIO registers in the VF PCI BAR. With the support of the VMM, the IO mediator can intercept the registration of the command communication channel by the VF KMD, record its location, and then register it through the GPU VF. All future GuC actions from the VF KMD will then be performed through the memory-based command communication channel. The IO mediator will track the location of this channel but will not begin monitoring it until the live migration starts. The IO mediator on the source server intercepts the submission of GPU workloads from the VF KMD through the command channel.

By monitoring the workload submission during the live migration, the IO mediator is also capable of shadowing the execlist LRCA context and the workload in the ring buffer associated with the execlist LRCA context. The IO mediator can scan and patch the GPU workload when copying the workload from the guest ring buffer to the shadow ring buffer.

Hardware in a GPU can provide various performance data about the status of the GPU's pipelines. This helps understanding the current state of the GPU. The software configures the GPU hardware and specifies the performance counters that want to be captured by the GPU hardware with a register called OACONTROL. At run time, the IO mediator can issue a GPU command called MI_REPORT_PERF_COUNT to let the GPU HW store a snapshot of performance counters in the graphics memory. When the MI_REPORT_PERF_COUNT command is received, a snapshot of the performance counter values is written to memory. The MI_REPORT_PERF_COUNT command causes the GPU hardware to write out a snapshot of performance counters to the address specified in the command. The dedicated counter values are written to the graphics memory whenever an MI_REPORT_PERF_COUNT command is placed in the ring buffer. For example, the report may contain the GPU memory text read performance counters (e.g., NOA performance counter: texture read), and the GPU memory writes to the render target (e.g., aggregating performance counter A26 which records the number of samples that are written to render target counted at 2×2 granularity).

The IO mediator can understand the GPU workload characteristics by collecting the GPU performance data. When a workload is submitted to the GPU (e.g., 3D-GPGPU pipeline) during the live migration, the IO mediator will scan the workload and copy it to the shadow ring buffer during the scan. During creating the shadow ring buffer, the IO mediator injects the GPU command MI_REPORT_PERF_COUNT at the beginning and end of the shadow ring buffer. The MI_REPORT_PERF_COUNTs instruction will write the performance data in two locations of the graphics memory: A and B.

When the workload is finished, the IO mediator analyzes the workload characteristics by comparing the performance counters snapshots A and B. If the workload input data is much more than the output data, the IO mediator knows that dispatching a copy of the workload to the destination server will not bring any gain. Thus, in this case, the IO mediator continues the regular dirty page marking process. The IO mediator just marks the output of the workload as dirty, and QEMU will pack and transfer them to the destination server.

If the IO mediator determines that the workload input data is much less than the output data from the GPU performance snapshots A and B, the IO mediator knows the optimization should be applied. In this case, the IO mediator skips marking these pages as dirty, so they do not need to be copied, and dispatches a copy of the workload in the device state management region. QEMU observes this data in the region, packs it into a bitstream, and transfers it to the destination server. The IO mediator on the destination server then unpacks and executes the workload.

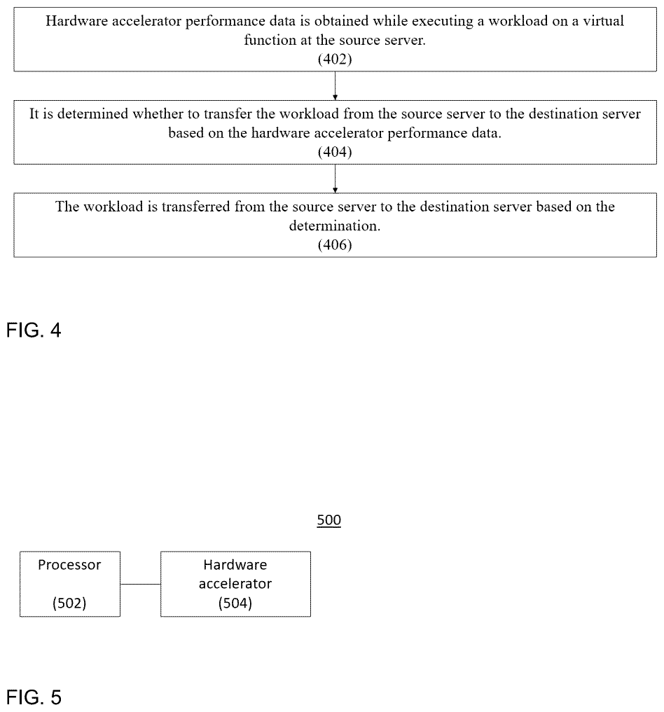

FIG. 4 is a flow diagram of an examples process for optimizing live migration of a VM from a source server to a destination server where hardware accelerator virtualization is used. Hardware accelerator performance data is obtained while executing a workload on a virtual function at the source server (402). The workload may be one of a GPU rendering workload, a GPU media workload, a GPU 3D workload, or an AI workload, etc. In some examples, the hardware accelerator is a GPU, the workload is a GPU workload, and the hardware accelerator performance data is GPU performance data. The hardware accelerator performance data may include an amount of output data the workload generates and an amount of input data to the workload. In some examples, the GPU performance data may be obtained by inserting, by an IO mediator in the source server, a GPU performance command when submitting the GPU workload to a GPU virtual function.

It is then determined whether to transfer the workload from the source server to the destination server based on the hardware accelerator performance data (404). In some examples, if it is determined that a ratio of the amount of output data the GPU workload generates to the amount of input data to the GPU workload does not exceed a threshold, output data generated by the GPU workload and marked as dirty page may be transferred to the destination server. If it is determined that a ratio of the amount of output data the GPU workload generates to the amount of input data to the GPU workload exceeds a threshold, an IO mediator in the source server may transfer the GPU workload to the destination server.

In some examples, the GPU workload may be scanned and copied to a shadow ring buffer, and a GPU command MI_REPORT_PERF_COUNT may be injected at both beginning and end of the shadow ring buffer. The GPU command MI_REPORT_PERF_COUNT captures a snapshot of GPU performance counters. It is then determined whether to transfer the GPU workload from the source server to the destination server based on two snapshots of the GPU performance counters.

The workload is transferred from the source server to the destination server based on the determination (406). In some examples, the IO mediator in the source server packs the GPU workload and streams the GPU workload within a live migration bitstream to the destination server.

FIG. 5 is a block diagram of an examples compute system 500 for optimizing live migration of a VM from a source server to a destination server where hardware accelerator virtualization is used. The compute system 500 includes a processor 502 and a hardware accelerator 504. The processor 502 is configured to run a VM and perform live migration of the VM from the compute system 502 to the destination server. The hardware accelerator 504 is configured to expose a plurality of virtual functions. The processor 502 is configured to obtain hardware accelerator performance data while executing a workload on a virtual function, determine whether to transfer the workload from the compute system 500 to the destination server based on the hardware accelerator performance data, and transfer the workload from the compute system 500 to the destination server based on the determination. The workload may be one of a GPU rendering workload, a GPU media workload, a GPU 3D workload, or an AI workload, etc. In some examples, the hardware accelerator performance data may include an amount of output data the workload generates and an amount of input data to the workload.

The hardware accelerator 504 may be a GPU, the workload is a GPU workload, and the hardware accelerator performance data is GPU performance data. In some examples, the processor 502 may be configured to obtain the GPU performance data by inserting a GPU performance command when submitting the GPU workload to a GPU virtual function.

In some examples, if it is determined that a ratio of the amount of output data the

GPU workload generates to the amount of input data to the GPU workload does not exceed a threshold, the processor 502 (an IO mediator running on the processor 502) may be configured to transfer output data generated by the GPU workload and marked as dirty page to the destination server. If it is determined that a ratio of the amount of output data the GPU workload generates to the amount of input data to the GPU workload exceeds a threshold, the processor 502 (an IO mediator running on the processor 502) may be configured to transfer the GPU workload to the destination server. In some examples, the processor 502 may be configured to pack the GPU workload and stream the GPU workload within a live migration bitstream to the destination server. In some examples, the processor 502 may be configured to scan, and copy, the GPU workload to a shadow ring buffer, inject a GPU command MI_REPORT_PERF_COUNT at both beginning and end of the shadow ring buffer, wherein the GPU command MI_REPORT_PERF_COUNT captures a snapshot of GPU performance counters, and determine whether to transfer the GPU workload to the destination server based on two snapshots of the GPU performance counters.

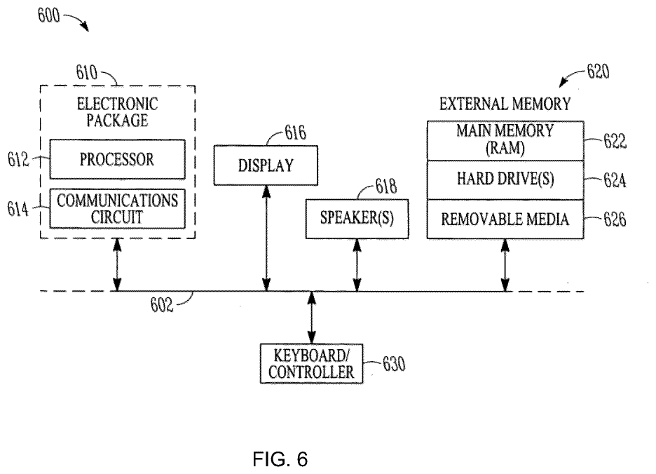

FIG. 6 is a block diagram of an electronic apparatus 600 incorporating at least one electronic assembly and/or method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), ﬂash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

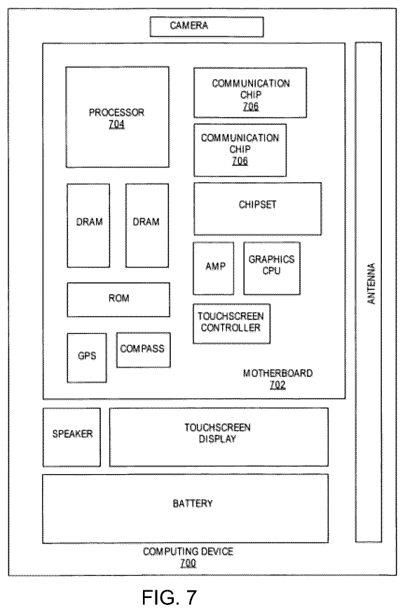

FIG. 7 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based P0P package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based P0P package that that includes a mold layer directly contacting a substrate, in accordance with implementations of the invention.

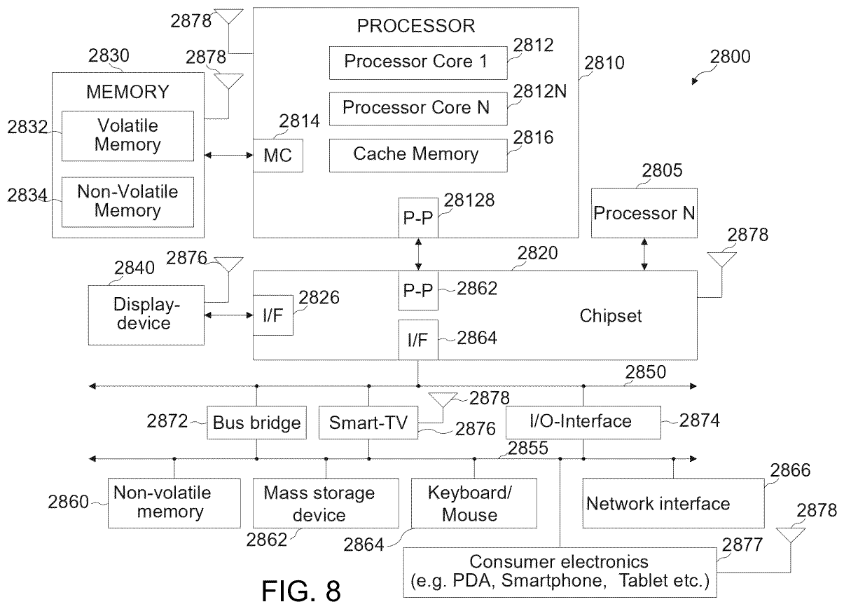

FIG. 8 is included to show an example of a higher level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 28 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for optimizing live migration of a VM from a source server to a destination server where hardware accelerator virtualization is used. The method includes obtaining hardware accelerator performance data while executing a workload on a virtual function at the source server, determining whether to transfer the workload from the source server to the destination server based on the hardware accelerator performance data, and transferring the workload from the source server to the destination server based on the determination.

Another example, (e.g., example 2) relates to a previously described example (e.g., example 1), wherein the hardware accelerator performance data includes an amount of output data the workload generates and an amount of input data to the workload.

Another example, (e.g., example 3) relates to a previously described example (e.g., example 2), wherein the hardware accelerator is a graphics processing unit (GPU), the workload is a GPU workload, and the hardware accelerator performance data is GPU performance data.

Another example, (e.g., example 4) relates to a previously described example (e.g., example 3), wherein the GPU performance data is obtained by inserting, by an input/output (IO) mediator in the source server, a GPU performance command when submitting the GPU workload to a GPU virtual function.

Another example, (e.g., example 5) relates to a previously described example (e.g., example 3 or 4), wherein if it is determined that a ratio of the amount of output data the GPU workload generates to the amount of input data to the GPU workload does not exceed a threshold, output data generated by the GPU workload and marked as dirty page is transferred to the destination server.

Another example, (e.g., example 6) relates to a previously described example (e.g., any one of examples 3-5), wherein if it is determined that a ratio of the amount of output data the GPU workload generates to the amount of input data to the GPU workload exceeds a threshold, an input/output (IO) mediator in the source server transfers the GPU workload to the destination server.

Another example, (e.g., example 7) relates to a previously described example (e.g., example 6), wherein the IO mediator in the source server packs the GPU workload and streams the GPU workload within a live migration bitstream to the destination server.

Another example, (e.g., example 8) relates to a previously described example (e.g., any one of examples 1-7), wherein the workload is one of a GPU rendering workload, a GPU media workload, a GPU 3D workload, or an AI workload.

Another example, (e.g., example 9) relates to a compute system for optimizing live migration of a VM to a destination server, comprising a processor configured to run a VM and perform live migration of the VM from the compute system to the destination server, and a hardware accelerator for exposing a plurality of virtual functions. The processor is configured to obtain hardware accelerator performance data while executing a workload on a virtual function, determine whether to transfer the workload from the compute system to the destination server based on the hardware accelerator performance data, and transfer the workload from the compute system to the destination server based on the determination.

Another example, (e.g., example 10) relates to a previously described example (e.g., example 9), wherein the hardware accelerator performance data includes an amount of output data the workload generates and an amount of input data to the workload.

Another example, (e.g., example 11) relates to a previously described example (e.g., example 10), wherein the hardware accelerator is a GPU, the workload is a GPU workload, and the hardware accelerator performance data is GPU performance data.

Another example, (e.g., example 12) relates to a previously described example (e.g., example 11), wherein the processor is configured to obtain the GPU performance data by inserting a GPU performance command when submitting the GPU workload to a GPU virtual function.

Another example, (e.g., example 13) relates to a previously described example (e.g., any one of examples 11-12), wherein the processor is configured to transfer output data generated by the GPU workload and marked as dirty page to the destination server if it is determined that a ratio of the amount of output data the GPU workload generates to the amount of input data to the GPU workload does not exceed a threshold.

Another example, (e.g., example 14) relates to a previously described example (e.g., any one of examples 11-13), wherein the processor is configured to transfer the GPU workload to the destination server if it is determined that a ratio of the amount of output data the GPU workload generates to the amount of input data to the GPU workload exceeds a threshold

Another example, (e.g., example 15) relates to a previously described example (e.g., example 14), wherein the processor is configured to pack the GPU workload and stream the GPU workload within a live migration bitstream to the destination server.

Another example, (e.g., example 16) relates to a previously described example (e.g., any one of examples 9-15), wherein the workload is one of a GPU rendering workload, a GPU media workload, a GPU 3D workload, or an AI workload.

Another example, (e.g., example 17) relates to a non-transitory machine-readable medium including code, when executed, to cause a machine to perform the method as in anyo one of examples 1-8.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may for instance, illustrate a high-level circuit diagram implementing the principles of the disclosure. Similarly, a flow chart, a flow diagram, a state transition diagram, a pseudo code, and the like may represent various processes, operations or steps, which may for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A method for optimizing live migration of a virtual machine (VM) from a source server to a destination server where hardware accelerator virtualization is used, comprising:
obtaining hardware accelerator performance data while executing a workload on a virtual function at the source server;
determining whether to transfer the workload from the source server to the destination server based on the hardware accelerator performance data; and
transferring the workload from the source server to the destination server based on the determination.

2. The method of claim 1, wherein the hardware accelerator performance data includes an amount of output data the workload generates and an amount of input data to the workload.

3. The method of claim 2, wherein the hardware accelerator is a graphics processing unit (GPU), the workload is a GPU workload, and the hardware accelerator performance data is GPU performance data.

4. The method of claim 3, wherein the GPU performance data is obtained by inserting, by an input/output (IO) mediator in the source server, a GPU performance command when submitting the GPU workload to a GPU virtual function.

5. The method of claim 3, wherein if it is determined that a ratio of the amount of output data the GPU workload generates to the amount of input data to the GPU workload does not exceed a threshold, output data generated by the GPU workload and marked as dirty page is transferred to the destination server.

6. The method of claim 3, wherein if it is determined that a ratio of the amount of output data the GPU workload generates to the amount of input data to the GPU workload exceeds a threshold, an input/output (IO) mediator in the source server transfers the GPU workload to the destination server.

7. The method of claim 6, wherein the IO mediator in the source server packs the GPU workload and streams the GPU workload within a live migration bitstream to the destination server.

8. The method of claim 1, wherein the workload is one of a graphics processing unit (GPU) rendering workload, a GPU media workload, a GPU 3D workload, or an artificial intelligence (AI) workload.

9. A compute system for optimizing live migration of a virtual machine (VM) to a destination server, comprising:
a processor configured to run a VM and perform live migration of the VM from the compute system to the destination server; and
a hardware accelerator for exposing a plurality of virtual functions,
wherein the processor is configured to obtain hardware accelerator performance data while executing a workload on a virtual function, determine whether to transfer the workload from the compute system to the destination server based on the hardware accelerator performance data, and transfer the workload from the compute system to the destination server based on the determination.

10. The compute system of claim 9, wherein the hardware accelerator performance data includes an amount of output data the workload generates and an amount of input data to the workload.

11. The compute system of claim 10, wherein the hardware accelerator is a graphics processing unit (GPU), the workload is a GPU workload, and the hardware accelerator performance data is GPU performance data.

12. The compute system of claim 11, wherein the processor is configured to obtain the GPU performance data by inserting a GPU performance command when submitting the GPU workload to a GPU virtual function.

13. The compute system of claim 11, wherein the processor is configured to transfer output data generated by the GPU workload and marked as dirty page to the destination server if it is determined that a ratio of the amount of output data the GPU workload generates to the amount of input data to the GPU workload does not exceed a threshold.

14. The compute system of claim 11, wherein the processor is configured to transfer the GPU workload to the destination server if it is determined that a ratio of the amount of output data the GPU workload generates to the amount of input data to the GPU workload exceeds a threshold.

15. The compute system of claim 14, wherein the processor is configured to pack the GPU workload and stream the GPU workload within a live migration bitstream to the destination server.

16. The compute system of claim 9, wherein the workload is one of a graphics processing unit (GPU) rendering workload, a GPU media workload, a GPU 3D workload, or an artificial intelligence (AI) workload.

17. A non-transitory machine-readable medium including code, when executed, to cause a machine to perform the method of claim 1.
